(19) United States
(12) Patent Application Publication
(10) Pub. No.: US 2009/0080559 A1
(43) Pub. Date: Mar. 26, 2009

(54) Antenna diversity by means of its through connection for receivers of digital radio signals

(76) Inventors: Michael Armbruster, Frickenhausen (DE); Thomas Adam, Bad Urach (DE)

Correspondence Address: K.F. ROSS P.C., 5683 RIVERDALE AVENUE, SUITE 203 BOX 900, BRONX, NY, 10471-0900, US

(21) Appl. No.: 11/919,957

(22) PCT Filed: May 11, 2005
(86) PCT No.: PCT/EP2006/004455

§ 371 Date: Nov. 5, 2007

(30) Foreign Application Priority Data
May 11, 2005 (DE) 10 2005 021 751.6

(51) Int. Cl. H04L 1/02

(52) U.S. Cl. 375/267; 375/E01.001

(57) ABSTRACT

The invention relates to an antenna diversity in which high-frequency signals (HF signals) received via a plurality of antennas are fed to a respective tuner (1, 3). The invention is characterized in that the intermediate frequency output signals (IF signals) of the tuners (1, 3) are fed to a connect-through device (5) that connects one IF signal each through to one subsequent demodulator (6).

The invention relates to an antenna-diversity system in which a plurality of antennas receive respective high-frequency signals (HF signals) that are each sent to a tuner, according to the features of the preamble of claim 1.

In digital radio receivers having more than one antenna it is common to use an MRC or MRC-like method for antenna diversity. One demodulator per antenna is generally necessary for this purpose.

To economize on component costs, antenna diversity may be carried out using only one demodulator by means of switching diversity (known from DE 39 26 336 A1, DE 196 36 125 A1, DE 197 39 898 A1, for example). Known approaches are provided with a changeover switch on the high-frequency side, upstream from the tuner.

The object of the invention, therefore, is to provide an antenna-diversity system for the mobile reception of high-frequency signals by means of which the disadvantages described above are avoided. A particular aim is to improve the signal quality and to avoid the necessity for the tuner to be in the immediate proximity of the associated antennas.

This object is achieved by the features of claim 1.

According to the invention, the intermediate-frequency output signals from the tuner are sent to a switching device that feeds one of the IF signals to a downstream demodulator. The advantage of the present invention, therefore, is that the reception signal is switched over on the intermediate-frequency (IF) level. Due to the fact that the reception signal is already amplified with respect to the received HF signal (for example, by an amplifier located upstream from the tuner or integrated therein) and has a constant high level as the result of level control, on account of the substantial insensitivity to interference there are no particular requirements for the spatial configuration of the tuner (proximity, for example) or for shielding, thereby greatly improving the signal quality. In addition, as a result of the invention it is no longer necessary to situate the tuner in the immediate proximity of the associated antennas.

Further features and advantages of the method according to the invention result from the subclaims.

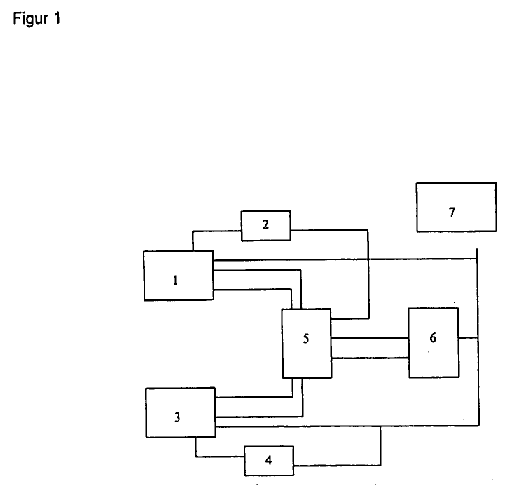

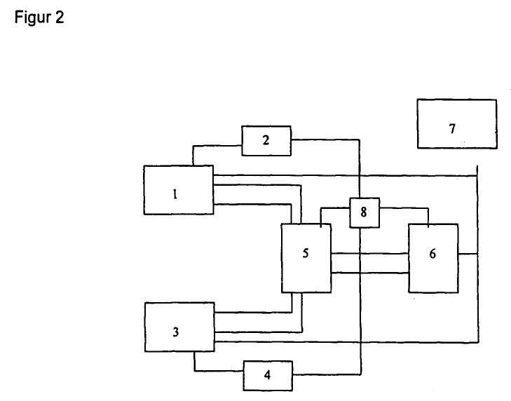

Illustrated embodiments of the invention, to which, however, the invention is not limited, are explained below and illustrated with reference to FIGS. 1 and 2.

The receiver is illustrated with two antennas by way of example; in principle, the method may be used with more than two antennas. For use in vehicles, four antennas, for example, have proven to be very well suited. A separate tuner 1, 3 is associated with each receiver antenna (not illustrated here). The objective is to switch over the reception signal to the intermediate-frequency (IF) level, it being unimportant whether a first IF or an additional IF is involved. In the circuit system according to FIGS. 1 and 2, a respective evaluating device 2, 4 and a downstream switching device 5 are associated with each of the tuners 1, 3. Downstream from the switching device 5 is located a demodulator 6, the output signals from which are sent to a playback device (not illustrated here) for playback of the received and processed high-frequency (HF) signals. In the present invention it is important that the high-frequency signals received by the antennas are not switched over upstream from the tuners, but, instead that the signals are first processed in the tuners and the respective output signals are sent from the tuners to the switching device 5 that feeds the best signal to the demodulation circuit 6.

One particular characteristic of IF that is applied in this case is that the IF is already amplified with respect to the received HF signal (for example, by an amplifier located upstream from the tuner or integrated therein) and has a constant high level as the result of level control. On account of the substantial is insensitivity to interference there are no particular requirements for the spatial configuration of the tuner (proximity, for example) or for shielding, although the IF signal, specifically in vehicles, reaches the switching device 5 via a long path from the tuners. This is because, due to the available space in the vehicle, as a result of high integration density of components it is often not possible to situate the tuner in the vicinity of the antenna, as required in the prior art, in order to avoid interfering emissions. The invention thus allows the tuner to be located at a distance from the antenna without impairment of signal quality, since the signals processed in the tuner are emitted as IF signals, only after which the signals are fed through.

For level control, in addition to the actual IF signal a signal for level control is also fed through. This signal is generated in the demodulator 6 and transmitted via the switching device 5 to the tuner 1 or 3 that is active at that time.

The decision of which IF signal to send to the demodulator 6 is made via devices for signal measurement and evaluation. When the antenna is active, the information for signal evaluation may be provided by the demodulator 6, among other devices.

It is not possible to measure or evaluate the alternative antenna using the demodulator, of which only one is provided. In this case a separate evaluating device 2 or 4 is therefore used. Since this evaluating device is able to operate according to a different measurement principle, reference tables or calculation formulas are used to produce a reference for the measurement variables of the evaluating devices 2 or 4 and 6. Since this reference may be dependent on the frequency and be subject to component tolerances, the reference may be learned by the reception system when receiving reference signals.

A control unit 7 assumes the control of all units and evaluation of the information provided by the evaluating devices 2 or 4 and 6.

As an alternative to the method described for FIG. 1, according to FIG. 2 the switching may be performed without the use of a controller. In this case, the information obtained from the evaluating devices 2, 4, and 6 is directly processed in a decision unit 8 and sent to the switching device 5.

The switching in each case occurs at defined times that are characterized in that no, or reduced, visible or audible impairment of the reception signal results.

The methods may also be used for mobile as well as portable or stationary receivers having more than one antenna.

An “active” antenna or tuner consistently refers to the antenna or tuner instantaneously used for representing the program (in contrast to the alternative antenna). Antenna diversity refers to a method for receiving, processing, and replaying high-frequency signals, and a corresponding device for carrying out such a method.

1. An antenna-diversity system in which high-frequency signals (HF signals) received via a plurality, of antennas are each fed to a tuner wherein the intermediate-frequency output signals (IF signals) from the tuners are sent to a switching device that feeds one of the IF signals to a downstream demodulator.

2. The antenna-diversity system according to claim 1 wherein the IF signal is amplified with respect to the received HF signal.

3. The antenna-diversity system according to claim 2 wherein the IF signal is amplified with respect to the received HF signal by an amplifier located upstream from the tuner or integrated therein.

4. The antenna-diversity system according to claim 1 wherein the level of the IF signal is controlled.

5. The antenna-diversity system according to claim 4 wherein means are provided for controlling the level of the IF signal.

6. The antenna-diversity system according to claim 1 wherein devices for signal measurement and evaluation are provided, by means of which a decision is made as to which IF signal to send from a tuner to the demodulator.

7. The antenna-diversity system according to claim 1 wherein a control unit is provided that assumes the control of all units and evaluation of the information obtained from the evaluating devices.

8. An antenna-diversity system comprising:
a plurality of antennas adapted to receive weak high-frequency signals;
respective tuner means close to and connected to the antennas for amplifying and converting the respective weak high-frequency signals into strong intermediate-frequency signals;
a demodulator remote from the tuner means; and
switch means remote from and connected to the tuner means and connected to the-demodulator for evaluating the signals from the tuner means and selecting and transmitting only the strongest of the signals from the tuner means to the demodulator.

9. An antenna-diversity method comprising:
receiving via a plurality of antennas weak high-frequency signals and feeding the received weak high-frequency signals to respective tuners close to the antennas;
amplifying and converting the respective weak high-frequency signals in the tuners into strong intermediate-frequency signals and feeding the strong intermediate-frequency signals to a switching circuit remote from the tuners; and
evaluating the signals from the tuner means in the switching circuit and selecting and transmitting only the strongest of the signals from the tuner means to a demodulator.
